(19) United States
(12) Patent Application Publication
(10) Pub. No.: US 2014/0253696 A1
(43) Pub. Date: Sep. 11, 2014

(54) 3-D IMAGE SHUTTER GLASSES

(71) Applicant: Kyoung Ho Choi, Seoul (KR)

(72) Inventor: Kyoung Ho Choi, Seoul (KR)

(21) Appl. No.: 14/350,660

(22) PCT Filed: Jul. 6, 2012
(86) PCT No.: PCT/KR2012/005378

§ 371 Date: Apr. 9, 2014

(30) Foreign Application Priority Data
Oct. 10, 2011 (KR) 10-2011-0103238

(51) Int. Cl. H04N 13/04

(52) U.S. Cl. CPC H04N 13/0429
USPC 348/51

(57) ABSTRACT

Disclosed are 3-D image shutter glasses. The 3-D image shutter glasses include a left-eye glass and a right-eye glass to alternately receive left-eye image data and right-eye image data from a display with a predetermined interval, and a transmission part to transmit an image received by one lens of the left-eye and right-eye glasses to an opposite lens.

### TECHNICAL FIELD

The disclosure relates to 3-D image shutter glasses.

### BACKGROUND ART

A 3-D image technology is provided for next generation information communication service, and applied to various fields from a high technology fiercely competed in demands and developments to application fields such as information communication, broadcasting, medical care, education and training, military games, an animation, a virtual reality, CADs, and industrial technologies. The 3-D technology is a core infra-technology of next generation information communication for realistic 3-D multimedia which has been required from various fields in common.

In general, the 3-D effect perceived by a person is derived from the complex interaction of the thickness variation degree of crystalline lens according to the position of an object to be observed, the angle difference between a target and both eyes of the person, the difference in the position of the target and the shape of the target that are recognized by left and right eyes, parallax according to the motion of an object, and effects resulting from various mentalities and memories. Among them, the binocular disparity, which occurs as both eyes of a person are horizontally spaced apart from each other by the distance of about 6 cm to about 7 cm, may be the most important cause providing the 3-D effect. In other words, the person views an object with a predetermined angular difference due to the binocular disparity allowing two images different from each other to come into two eyes, and the information of the images is transferred to the brain of the person through the retina. In this case, the brain of the person exactly combines the information of the two images with each other, so that the person can perceive the original 3-D image.

In order to realize the 3-D image, there are a passive scheme employing polarizing filters and an active scheme employing a shutter glass.

The polarizing filter scheme is to separate a left-eye image and a right-eye image from each other by using a light shielding effect resulting from the combination of polarizing elements orthogonal to each other. According to the polarizing filter scheme, the left and right images are projected onto a screen through a beam projector equipped with polarizing filters orthogonal to each other, and a person can view the left and right images, which are independent from each other, through glasses having the polarizing filters to perceive the 3-D effect. According to the passive polarizing filter scheme, high-definition color moving pictures can be displayed, and plural persons can simultaneously view the 3-D image. In addition, since the left and right images may be viewed in the separated state due to the characteristics of the polarized glasses, the 3-D effect can be easily perceived. However, the polarizing filter scheme has a limitation in that the 3-D effect may be degraded when glasses having a low polarizing ability are used. In addition, the polarizing filter scheme may require special screens such as a silver screen or a pearl screen to prevent polarization interference.

As shown in FIG. 1, the shutter glass scheme employs a display part to display left and right images according to frames and shutter glasses 50 open/closed in synchronization with the display part. According to the shutter glass scheme, when left and right images formed to make the binocular disparity are displayed on the display part 100 according to the frames, only a left side 57 of the shutter glasses 50 is open in the display of the left image, and only a right side 55 of the shutter glasses 50 is open in the display of the right image in synchronization with the display part 100, thereby making the binocular disparity.

However, although the display is a device for the use of many persons, a device for a person who is visually handicapped, in detail, a person having one handicapped eye is not developed at the moment in which 3-D images are popularized.

### DISCLOSURE OF INVENTION

### Technical Problem

According to the embodiment of the disclosure, even a person having one handicapped eye can view images without damages. In addition, functional manipulation can be performed in the glasses instead of the display device, so that remaining viewers can view images without the interruption. Accordingly, all viewers can smoothly view images.

### Solution to Problem

According to the embodiment, there is provided 3-D image shutter glasses including a left-eye glass and a right-eye glass to alternately receive left-eye image data and right-eye image data from a display with a predetermined interval, and a transmission part to transmit an image received by one lens of the left-eye and right-eye glasses to an opposite lens.

### Advantageous Effects of Invention

According to the embodiment of the disclosure, even a person having one handicapped eye can view images without damages. In addition, functional manipulation can be performed in the glasses instead of the display device, so that remaining viewers can view images without the interruption. Accordingly, all viewers can smoothly view images.

### BRIEF DESCRIPTION OF DRAWINGS

FIG. 1 is a view showing shutter glasses scheme according to the related art;

FIG. 2 is a view showing images input to glasses through the shutter glass scheme according to the related art;

FIG. 3 is a view showing images input to glasses through the shutter glass scheme according to the embodiment of the disclosure; and

FIG. 4 is a flowchart showing a procedure of processing images represented in the shutter glasses according to the embodiment of the disclosure.

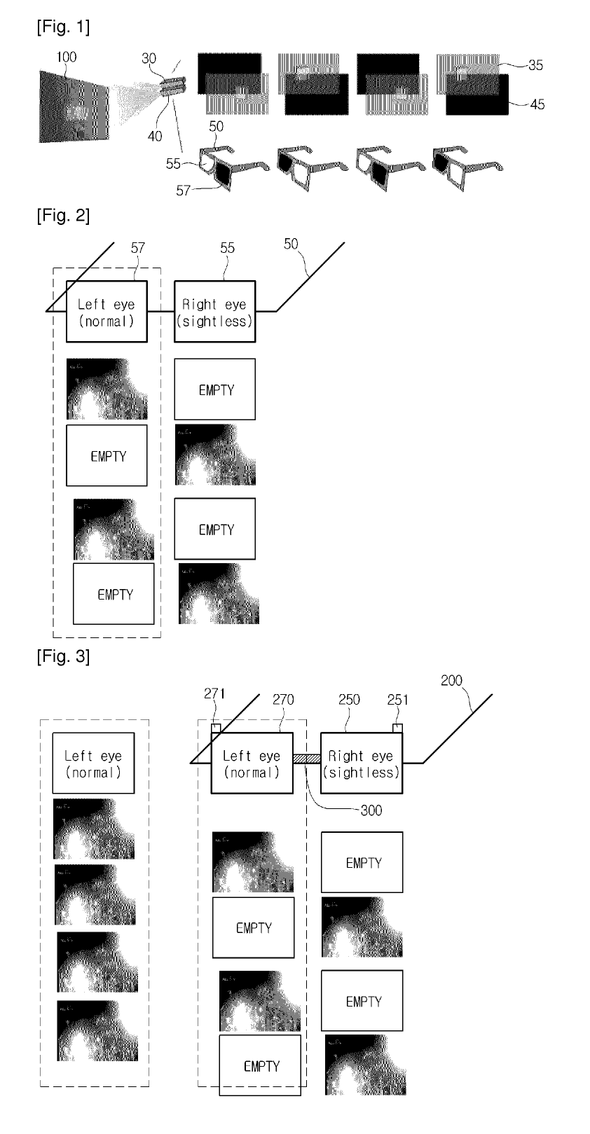

### MODE FOR THE INVENTION

Hereinafter, an exemplary embodiment of the disclosure will be described with reference to accompanying drawings. The details of other embodiments are contained in the following detailed description and accompanying drawings. The advantages and features of the disclosure, and the method of accomplishing the advantages and features of the disclosure will be apparent through the following description together with accompanying drawings. The same reference numerals will be assigned to the same elements.

FIG. 2 is a view showing images input to the glasses through a shutter glass scheme according to the embodiment. In glasses 50 according to the related art, a right-eye glass 55 and a left-eye glass 57 alternately receive images. In other words, when the right-eye glass 55 receives images, the left-eye glass 57 is closed. In contrast, when the left-eye glass 57 receives images, the right-eye glass 55 is closed.

Right and left images may be supplied from two cameras that have taken the images at different angles by taking binocular disparity into consideration.

As described above, in the situation that the left and right images are alternately input to the glasses 50, if only one pupil of both eyes is normal (according to the present embodiment, a case in which a left eye is normal will be described for the illustrative purpose), the left-eye glass 57 may be closed at the time when the right image is input, so that the frame loss may occur. In other words, since images (gray-scale images) at a moment when the left image is input and the right image is blocked are input into the left eye, the frame loss occurs, so that the right image cannot be viewed.

FIG. 3 is a view showing images input to glasses through a shutter glass scheme according to the embodiment of the disclosure.

3-D glasses 200 of FIG. 3 may include a left image input switch 271, a right image input switch 251, and a transmission part 300 interposed between a left-eye glass 270 and a right-eye glass 250 to transceive images from one lens to the other lens.

In addition, the 3-D glasses 200 may include a driving part to transmit a driving signal allowing the left-eye glass 270 and the right-eye glass 250 to be alternately open or closed.

According to the shutter glass scheme, left and right images are alternately displayed on a display sequentially. At the time when the left image is displayed, only the left-eye glass 270 receives images through the glasses 200, and the right-eye glass 250 is closed. In addition, at the time when the right images are displayed, only the right-eye glass 270 receives the right images through the glasses 200, and the left-eye glass 270 is closed.

The transmission frequency of the image data is identical to a frequency at which the left-eye glass 270 and the right-eye glass 250 of the 3-D glasses 200 are closed.

A viewer having only one normal pupil of both eyes can receive images through a corresponding lens by using a left-image input switch 271 and a right-image input switch 251.

The left-image and right-image input switches 271 and 251 may be substituted to one switch. In this case, whenever the user presses the switch, the user may select one of a general viewing mode, a left-eye viewing mode, and a right-eye viewing mode.

For example, if a viewer having a normal sight at only a left eye thereof clicks the left-image input switch 271, the 3-D glasses 200 receives the left images, and right images to be input through the right-eye glass 250 are transmitted to the left-eye glass 27. In this case, the right images to be input through the right-eye glass 270 can be transmitted to the left-eye glass 270 through the transmission part 300.

The transmission part may be disposed between the left-eye glass 270 and the right-eye glass 250 or may be disposed at one part of the body of the 3-D glasses 200.

Through the above structure, the right images to be input to the right-eye glass 250 are transmitted to the left-eye glass 270. Therefore, the user can view the images without the frame loss.

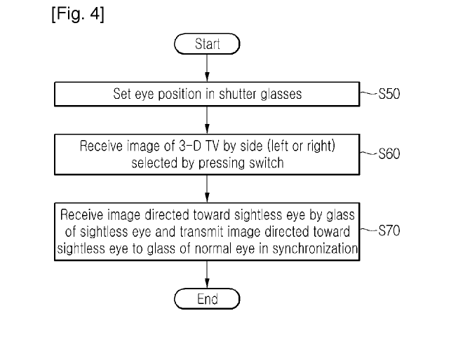

FIG. 4 is a flowchart showing a procedure of processing images shown on the glasses according to the embodiment of the disclosure. If a user selects a lens corresponding to a normal pupil by using a switch (step S50), the glasses 200 distinguishes between a lens corresponding to a normal eye and a lens corresponding to an abnormal lens. If the user does not select the lens by using the switch, the glasses naturally serve as a typical shutter glasses.

The images are received to the lens selected by the switch in the next step (step S60). The images for the sightless eye are received by a related lens and transmitted to a lens for an eye having a sight through the transmission part 300 (step S70).

Since the above procedure is performed by the glasses instead of the display general viewers having both normal eyes thereof can view images without interruption, and a user viewing images through only one eye can view images without the loss of images.

Any reference in this specification to one embodiment, an embodiment, example embodiment, etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. 3-D image shutter glasses comprising:
a left-eye glass and a right-eye glass to alternately receive left-eye image data and right-eye image data from a display with a predetermined interval; and
a transmission part to transmit an image received by one lens of the left-eye and right-eye glasses to an opposite lens.

2. The 3-D image shutter glasses of claim 1, wherein the transmission part is interposed between the left-eye glass and the right-eye glass.

3. The 3-D image shutter glasses of claim 1, further comprising switches connected to the left-eye glass and the right-eye glass to select one among a general viewing mode, a left-eye viewing mode, and a right-eye viewing mode.

4. The 3-D image shutter glasses of claim 3, wherein the switches are connected to the left-eye glass and the right-eye glass, respectively.

5. The 3-D image shutter glasses of claim 1, further comprising a driving part to transmit a driving signal so that the left-eye glass and the right-eye glass are alternately and sequentially open or closed according to times.

6. The 3-D image shutter glasses of claim 1, wherein a transmission frequency for the left-eye and right-eye image data is identical to a reception frequency of the left-eye glass and the right-eye glass.

7. A method of receiving a 3-D image, the method comprising:
alternately receiving a left image and a right image of the 3-D image;
receiving one image of the left and right images of a display through one corresponding lens of the left-eye glass and the right-eye glass; and
transmitting a remaining image of the left and right images to the one corresponding lens through a remaining corresponding lens of the left-eye glass and the right-eye glass.

8. The method of claim 7, wherein the receiving of the one image and the transmitting of the remaining image are alternately performed with a time difference.
